(19) United States
(12) Patent Application Publication
(10) Pub. No.: US 2025/0135408 A1
(43) Pub. Date: May 1, 2025

(54) POLYTETRAFLUOROETHYLENE (PTFE) MEMBRANES WITH GRADIENT PORE STRUCTURES AND METHODS FOR PREPARING THE SAME

(71) Applicant: FEATURE-TEC (SHANGHAI) ADVANCED MATERIALS CO., LTD., Shanghai (CN)

(72) Inventor: Cuijun CHEN, Shanghai (CN)

(73) Assignee: FEATURE-TEC (SHANGHAI) ADVANCED MATERIALS CO., LTD., Shanghai (CN)

(21) Appl. No.: 18/832,495

(22) PCT Filed: Dec. 19, 2023
(86) PCT No.: PCT/CN2023/139841

§ 371 Date: Jul. 23, 2024

(30) Foreign Application Priority Data
Dec. 19, 2022 (CN) 202211631082.0

(51) Int. Cl. B01D 71/36; B01D 39/16; B01D 67/00; B01D 69/12

(52) U.S. Cl. CPC B01D 71/36; B01D 39/1623; B01D 67/0002; B01D 69/1213; B01D 2323/081; B01D 2325/04

(57) ABSTRACT

A polytetrafluoroethylene (PTFE) membrane with a gradient pore structure and a method for preparing the same are disclosed. A cross-section of the PTFE membrane has the gradient pore structure, and a first porous outer surface and a second porous outer surface of the PTFE membrane have fibers and nodes with different microstructures. The first porous outer surface has an island-like microstructure formed by a plurality of interconnected relatively-small nodes, and the second porous outer surface has an H-shaped ladder-like microstructure formed by a plurality of interconnected relatively-large nodes. The PTFE membrane produced by this method features low resistance and high flow rate while maintaining thickness and filtration precision. The improvement in filtration efficiency enhances the capture of contaminants. For a given transmembrane pressure drop, the high permeability or high flow capacity of the membrane reduces resistance loss, shortens filtration time, and thus reduces energy costs.

### CROSS-REFERENCE TO RELATED APPLICATIONS

This application claims priority to Chinese Patent Application No. 202211631082.0, filed on Dec. 19, 2022, the entire contents of each of which are hereby incorporated by reference.

### TECHNICAL FIELD

The present disclosure relates to the field of polymer filtration membrane materials, and in particular relates to a polytetrafluoroethylene (PTFE) membrane with a gradient pore structure and a method for preparing the same.

### BACKGROUND

Expanded polytetrafluoroethylene (hereinafter referred to as PTFE) membranes with a porous structure have found widespread application in the fields of liquid and gas filtration. The PTFE membranes possess high chemical inertness and thermal stability under extreme temperatures, enabling their use under harsh working conditions.

As proposed in U.S. Pat. No. 3,953,566A, PTFE resin and a lubricant are mixed to form a raw material. The mixed PTFE raw material is molded and paste extruded. After removing the lubricant from the extruded material, the PTFE product is stretched to produce a porous PTFE product. Characteristics of the expanded PTFE materials lie in their porous microstructure, connected by fibrils and nodes, with pore sizes that are relatively uniform and consistent throughout the interior and two surfaces of the membrane, forming a symmetric pore structure.

Filtration materials with a symmetric pore structure can achieve high filtration precision. The smaller the pore size, the more precise the filtration or separation, but smaller pores typically reduce the permeability of liquids or gases through the membrane, failing to provide a high contaminant holding capacity. Conversely, increasing the pore size of the filtration material to enhance membrane flow capacity results in fewer captured particles, thus reducing filtration efficiency.

To increase a processing volume per unit area and unit time and improve filtration rates while maintaining a certain pore size, it is necessary to significantly increase a count of pores or minimize a thickness of the membrane material. Under specific production conditions, significantly increasing the count of pores per unit area is extremely challenging. Furthermore, although reducing the thickness of the filtration material can improve filtration rates, it weakens a mechanical strength of the membrane. The key to developing filtration materials lies in finding the ideal combination of high permeability and high filtration precision, ensuring filtration efficiency while maintaining low resistance, high flow rates, and high contaminant holding capacity. As a technology to overcome this drawback, asymmetric porous membranes have greater processing capacity under the same filtration or separation conditions.

Although the filtration properties of porous PTFE membranes are continuously improving, achieving PTFE filtration membranes that simultaneously offer small particle size capture and low flow resistance remains one of the technical challenges in this field.

Filtration materials with asymmetric pore structures ensure high filtration precision while offering advantages such as low pressure drop and long service life, making them widely used in the filtration and separation fields. For example, CN107810047A discloses an asymmetric PTFE composite with a macroscopically textured surface, where two membrane surfaces of the PTFE composite have different bubble point pressure values. In the method for preparing the PTFE composite, a second PTFE membrane must be expanded in a longitudinal or transverse direction while wetted, i.e., before a lubricant is removed, which is difficult to implement and can easily cause irreversible damage to a PTFE strip. Although the membrane produced by this method has a unique macroscopically textured surface, the surface may exhibit one or more raised strands that may lead to uneven interlayer stress when combined with other support layers.

As another example, U.S. Pat. No. 4,248,924A provides a porous membrane material made of PTFE with an asymmetric structure, prepared by stretching the membrane using a pair of rotating rollers with a temperature difference of 50° C. or higher. The temperature gradient created in a thickness direction by the temperature difference between front and back surfaces of the membrane, combined with a compressive force in a thickness direction, generates an asymmetric structure in the resulting porous membrane material. This structure is characterized by fiber configurations on a front surface differing from those on a rear surface. Often, due to a thinness of the stretched membrane, the temperature gradient generated in the thickness direction is limited, making it difficult to effectively control the asymmetric structure within the membrane material.

In view of the above, it is necessary to improve the asymmetric membrane materials and methods for preparing the same in the prior art to address these issues.

### SUMMARY

The purpose of the present disclosure is to disclose a polytetrafluoroethylene (PTFE) membrane with a gradient pore structure. The PTFE membrane combines the characteristics of low flow resistance and small pore size, making it excellent in terms of filtration rate and reliable retention accuracy for both liquid and gas filtration.

To achieve the aforementioned objective, the present disclosure provides a PTFE membrane with a gradient pore structure, wherein a cross-section of the PTFE membrane has the gradient pore structure. A first porous outer surface and a second porous outer surface of the PTFE membrane have fibers and nodes with different microstructures the first porous outer surface has an island-like microstructure formed by a plurality of interconnected relatively-small nodes, and the second porous outer surface has an H-shaped ladder-like microstructure formed by a plurality of interconnected relatively-large nodes.

In some embodiments, each of the relatively-small nodes has a circular structure, and an average diameter of the relatively-small nodes is in a range of 0.30 μm to 1.50 μm.

In some embodiments, the relatively-small nodes are connected by a plurality of short and thick microfibers, an average length of the short and thick microfibers is in a range of 0.2 μm to 2.5 μm, an average diameter of the short and thick microfibers is in a range of 0.05 μm to 0.2 μm, and an aspect ratio of the short and thick microfibers is in a range of 2 to 20.

In some embodiments, each of the relatively-large nodes has an elongated oval structure, an average length of the relatively-large nodes is in a range of 0.5 μm to 10 μm, and an average width of the relatively-large nodes is in a range of 0.5 μm to 2 μm.

In some embodiments, the relatively-large nodes are connected by a plurality of long and thin microfibers, an average length of the long and thin microfibers is in a range of 1 μm to 10 μm, an average diameter of the long and thin microfibers is in a range of 5 nm to 200 nm, and an aspect ratio of the long and thin microfibers is in a range of 10 to 200.

Another purpose of the present disclosure is to provide a method for preparing a polytetrafluoroethylene (PTFE) membrane with a gradient pore structure. The method may include the following operations:
(1) Mixing isoalkane with PTFE dispersion resin to obtain a PTFE resin mixture, and pressing the PTFE resin mixture into a cylindrical preform.
(2) Extruding, using an extruder and T-shaped extrusion dies with different specifications, the cylindrical preform into three continuous rectangular strip sheets with different thicknesses and a same width, designated as a first sheet, a second sheet, and a third sheet.
(3) Stacking the first sheet, the second sheet, and the third sheet along a width direction of the three strip sheets in an increasing or decreasing order of thickness, and passing the three strip sheets through a pair of metal rollers along a length direction of the three strip sheets to be calendered to a thickness in a range of 0.05 mm to 1 mm, forming a laminate.
(4) Drying the laminate at a temperature in a range of 200 to 250° C., and expanding the laminate in a speed direction at a temperature in a range of 250 to 350° C. with a stretching rate in a range of 20%/s to 3000%/s and an expansion ratio in a range of 50% to 900%, forming a uniaxially stretched product.
(5) Expanding the uniaxially stretched product at a temperature in a range of 200 to 400° C. with a stretching rate in a range of 5%/s to 500%/s and an expansion ratio in a range of 300% to 3000% in a direction perpendicular to the speed direction, thereby forming the PTFE membrane with the gradient pore structure.

In some embodiments, in operation (1), the isoalkane and the PTFE dispersion resin may be uniformly mixed in a weight ratio in a range of 15% to 30% to obtain the PTFE resin mixture, and the PTFE resin mixture may be dried at a temperature not less than 20° C. for more than 12 hours before being pressed as the cylindrical preform.

In some embodiments, in operation (2), the cylindrical preform may be extruded through the T-shaped extrusion dies with different specifications at a compression ratio in a range of 20 to 500 to form the three continuous rectangular strip sheets with different thicknesses and the same width, designated as the first sheet, the second sheet, and the third sheet, wherein: a thickness of the second sheet may be at least 1.2 times of a thickness of the first sheet, a thickness of the third sheet may be at least 1.2 times of the thickness of the second sheet, and a compression ratio for the first sheet may be at least 2.5 times of a compression ratio for the second sheet and 3 times of a compression ratio for the third sheet.

In some embodiments, in operation (4), the laminate may be expanded in the speed direction at a stretching rate in a range of 50%/sec to 2000%/sec and an expansion ratio in a range of 80% to 800% to form the uniaxially stretched product.

In some embodiments, in operation (5), the uniaxially stretched product may be expanded in the direction perpendicular to the speed direction at a stretching rate in a range of 20%/sec to 300%/sec and an expansion ratio in a range of 500% to 2500%, thereby forming the PTFE membrane with the gradient pore structure.

Compared to the prior art, the beneficial effects of the present disclosure are: the PTFE membrane with the gradient pore structure prepared by the method maintains low resistance and high flow rate without reducing thickness or filtration accuracy, and the improved filtration efficiency enhances the capture of contaminants. For a given transmembrane pressure drop, the high permeability or high flow capability of the membrane reduces resistance loss, shortens filtration time, and thereby reduces energy costs. In addition, these characteristics can provide more compact, cost-effective systems.

### BRIEF DESCRIPTION OF THE DRAWINGS

FIG. 1 is a cross-sectional view of a PTFE laminate according to the present disclosure;

FIG. 2 is a 2000× scanning electron microscope (SEM) photograph of a first porous outer surface of a PTFE membrane in Embodiment 1 of the present disclosure;

FIG. 3 is a 2000×SEM photograph of a second porous outer surface of a PTFE membrane in Embodiment 1 of the present disclosure;

FIG. 4 is a 2000×SEM photograph of a first porous outer surface of a PTFE membrane in Embodiment 2 of the present disclosure;

FIG. 5 is a 2000×SEM photograph of a second porous outer surface of a PTFE membrane in Embodiment 2 of the present disclosure;

FIG. 6 is a 2000×SEM photograph of a first porous outer surface of a PTFE membrane in Embodiment 3 of the present disclosure;

FIG. 7 is a 2000×SEM photograph of a second porous outer surface of a PTFE membrane in Embodiment 3 of the present disclosure;

FIG. 8 is a 2000×SEM photograph of a first porous outer surface of a PTFE membrane in Embodiment 4 of the present disclosure;

FIG. 9 is a 2000×SEM photograph of a second porous outer surface of a PTFE membrane in Embodiment 4 of the present disclosure;

FIG. 10 is a 2000×SEM photograph of a first porous outer surface of a PTFE membrane in Embodiment 5 of the present disclosure;

FIG. 11 is a 2000×SEM photograph of a second porous outer surface of a PTFE membrane in Embodiment 5 of the present disclosure;

FIG. 12 is a 2000×SEM photograph of a first porous outer surface of a PTFE membrane in Embodiment 6 of the present disclosure; and

FIG. 13 is a 2000×SEM photograph of a second porous outer surface of a PTFE membrane in Embodiment 6 of the present disclosure.

### DETAILED DESCRIPTION

The present disclosure will be described in detail below in conjunction with the embodiments shown in the accompanying drawings. However, it should be noted that these embodiments are not limiting to the invention. Any equivalent transformations or substitutions in function, method, or structure made by those of ordinary skill in the art based on these embodiments fall within the scope of protection of the present disclosure.

A method for preparing a polytetrafluoroethylene (PTFE) membrane with a gradient pore structure according to the present disclosure may include the following operations:
(1) First, an isoalkane-based lubricant may be mixed with polytetrafluoroethylene (PTFE) dispersion resin at a weight ratio of 15-30% to obtain a PTFE resin mixture. The PTFE resin mixture may be dried at a temperature not less than 20° C. for more than 12 hours, and then pressed into a cylindrical preform.
(2) The cylindrical preform may be extruded into three continuous rectangular strip sheets with different thicknesses and a same width using an extruder and T-shaped extrusion dies with different specifications at a compression ratio of 20-500, preferably 30-250. The three continuous rectangular strip sheets may be designated as a first sheet, a second sheet, and a third sheet, respectively.

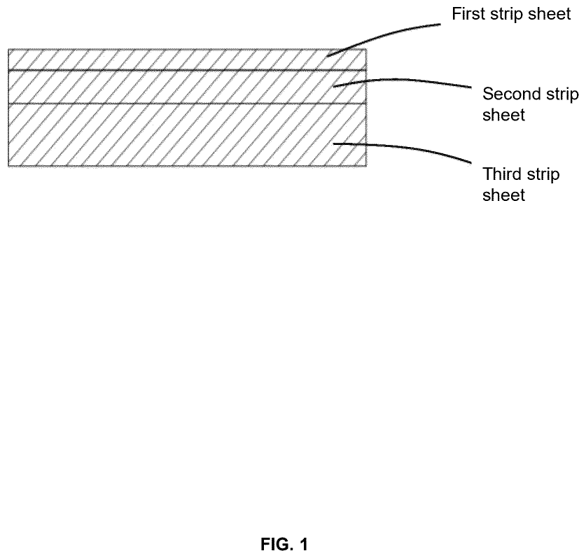

A thickness of the second sheet may be at least 1.2 times of a thickness of the first sheet, and preferably, the thickness of the second sheet may be 1.2-5 times of the thickness of the first sheet. A thickness of the third sheet may be at least 1.2 times of the thickness of the second sheet, and preferably, the thickness of the third sheet may be 1.2-5 times of the thickness of the second sheet. A compression ratio for the first sheet may be at least 2.5 times of a compression ratio for the second sheet and 3 times of a compression ratio for the third sheet.
(3) The first sheet, the second sheet, and the third sheet may be stacked along a width direction of the three strip sheets in an increasing or decreasing order of thickness, and the three strip sheets may be passed through a pair of metal rollers along a length direction of the three strip sheets to be calendered to a thickness in a range of 0.05 mm to 1 mm, preferably 0.15-0.6 mm, forming a laminate as shown in FIG. 1.
(4) The laminate may be dried at a temperature in a range of 200 to 250° C., and expanded in a speed direction at a temperature in a range of 250 to 350° C. with a stretching rate in a range of 20%/sec to 3000%/sec, preferably 50%/sec to 2000%/sec, and with an expansion ratio in a range of 50% to 900%, preferably 80%-800%, forming a uniaxially stretched product.
(5) The uniaxially stretched product may be expanded at a temperature in a range of 200 to 400° C. with a stretching rate in a range of 5%/sec to 500%/sec, preferably 20%/sec to 300%/sec, and with an expansion ratio in a range of 300% to 3000%, preferably 500%-2500%, in a direction perpendicular to the speed direction, thereby forming the PTFE membrane with the gradient pore structure.

A cross-section of the PTFE membrane has the gradient pore structure, and the PTFE membrane has two outer surfaces: a first porous outer surface and a second porous outer surface. The two outer surfaces have fibers and nodes with different microstructures.

The first porous outer surface has an island-like microstructure formed by a plurality of interconnected relatively-small nodes. Each of the relatively-small nodes has a circular structure, and an average diameter of the relatively-small nodes may be in a range of 0.30 μm to 1.50 μm. The relatively-small nodes may be connected by a plurality of short and thick microfibers, wherein an average length of the short and thick microfibers may be in a range of 0.2 μm to 2.5 μm, an average diameter of the short and thick microfibers may be in a range of 0.05 μm to 0.2 μm, and an aspect ratio of the short and thick microfibers may be in a range of 2 to 20.

The second porous outer surface has an H-shaped ladder-like microstructure formed by a plurality of interconnected relatively-large nodes. Each of the relatively-large nodes has an elongated oval structure, an average length of the relatively-large nodes may be in a range of 0.5 μm to 10 μm, and an average width of the relatively-large nodes may be in a range of 0.5 μm to 2 μm. The relatively-large nodes may be connected by a plurality of long and thin microfibers, wherein an average length of the long and thin microfibers may be in a range of 1 μm to 10 μm, an average diameter of the long and thin microfibers may be in a range of 5 nm to 200 nm, and an aspect ratio of the long and thin microfibers may be in a range of 10 to 200.

### Testing Methods for the PTFE Membrane:

### 1. Thickness Measurement:

The PTFE membrane or the three strip sheets may be placed between a spindle and an anvil of a Mitutoyo 7327 thickness gauge to determine a thickness of the PTFE membrane. An average value of three measurements may be used to determine the thickness of the PTFE membrane.

### 2. Bubble Point Measurement:

A bubble point and a mean flow pore size may be measured using a capillary flow porometer (Porolux 500, Porometer NV, Belgium) in accordance with the general guidance of ASTM F316-03. A sample PTFE membrane may be placed in a sample chamber and wetted with a test liquid having a surface tension of 16 dynes/cm. An average value of two measurements of the bubble point and mean flow pore size may be used as the value representing the bubble point and mean flow pore size.

### 3. Scanning Electron Microscope Images:

SEM images may be generated using a cold field emission scanning electron microscope (Hitachi Regulus 8100).

### 4. Node and Fiber Size Measurement:

SolidWorks 2014 software (Dassault Systèmes, France) may be used for proportional measurements of SEM photographs, and the measurements may be converted into actual node and fiber sizes using the scale bar in the SEM photographs.

The following embodiments are provided to further illustrate the present disclosure, but the present disclosure is not limited to these embodiments.

### Embodiment 1

Daikin F-106 polytetrafluoroethylene (PTFE) dispersion resin was uniformly mixed with 18.3% by weight of isoalkane (ExxonMobil ISOPAR M) and placed in a constant temperature oven at 25° C. for 18 hours. The PTFE resin mixture was pressed into a cylindrical preform and then extruded through a T-shaped die at a compression ratio of 195 to obtain a continuous first strip sheet with a rectangular cross-section. A thickness of the first strip sheet was 0.4 mm.

Asahi Glass CD-126E PTFE dispersion resin was uniformly mixed with 25.6% by weight of isoalkane (ExxonMobil ISOPAR K) and placed in a constant temperature oven at 25° C. for 18 hours. The PTFE resin mixture was pressed into a cylindrical preform and then extruded through T-shaped dies with different specifications at a compression ratio of 49 to obtain a continuous second strip sheet with a rectangular cross-section and, and at a compression ratio of 37 to obtain a continuous third strip with a rectangular cross-section, respectively. A thickness of the second strip sheet was 0.9 mm and a thickness of the third strip sheet was 1.2 mm.

The three strip sheets with different thicknesses were stacked along a width direction of the three strip sheets in an increasing or decreasing order of thickness, then passed through a pair of metal rollers along a length direction of the three strip sheets, and calendered in a thickness direction of the three strip sheets to 0.3 mm to form a laminate. The laminate was dried to remove additive oil, and then the dried laminate was expanded in a speed direction using a longitudinal stretching mechanism at a roller temperature of 300° C. with a stretching rate of 117%/sec and an expansion ratio of 230%. The longitudinally stretched product (base band) was then transversely expanded (i.e., expanded in a direction perpendicular to the speed direction) using a transverse stretching machine at a stretching temperature of 250° C. with a stretching rate of 22%/s and an expansion ratio of 2000%. Finally, the stretched product was heat-set to form a PTFE membrane.

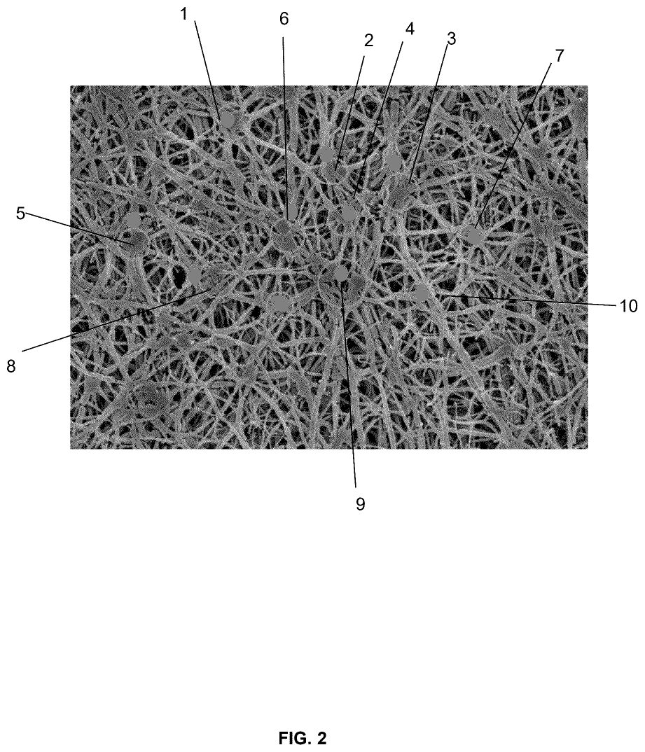

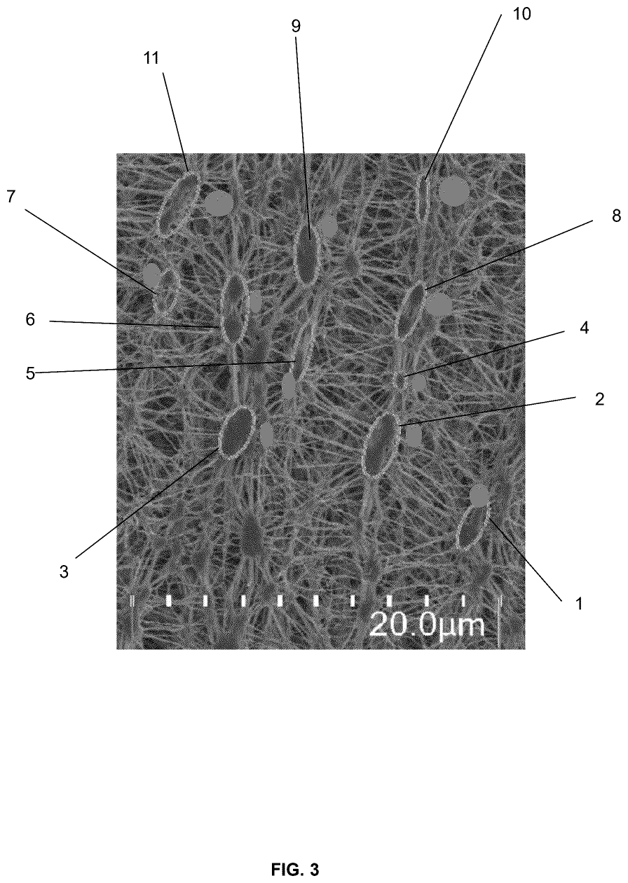

As described above, the obtained PTFE membrane has a first porous outer surface and a second porous outer surface with different microstructures. As shown in FIGS. 2-3, FIG. 2 is a scanning electron microscope (SEM) photograph taken at 2000× magnification of the first porous outer surface of the PTFE membrane, showing an island-like microstructure formed by a plurality of interconnected relatively-small nodes. FIG. 3 is an SEM photograph taken at 2000× magnification of the second porous outer surface of the PTFE membrane, showing an H-shaped ladder-like microstructure formed by a plurality of interconnected relatively-large nodes.

The nodes in the SEM photograph in FIG. 2 were proportionally measured using SolidWorks 2014 software. The node sizes are shown in Table 1 below.

TABLE 1
Node sizes on the first porous outer surface

| | Node Number | | | | | | | | | | |
|---|---|---|---|---|---|---|---|---|---|---|---|
| | 1 | 2 | 3 | 4 | 5 | 6 | 7 | 8 | 9 | 10 | |
| | Measurement Diameter (mm) | | | | | | | | | | |
| | 90 | 62 | 92 | 74 | 78 | 86 | 62.75 | 92 | 120 | 77 | |
| | Scale | | | | | | | | | | Average |
| | 504.34:5 | | | | | | | | | | Value |
| Diameter - | 0.892 | 0.615 | 0.912 | 0.734 | 0.773 | 0.853 | 0.622 | 0.912 | 1.190 | 0.763 | 0.827 |
| Actual | | | | | | | | | | | |
| Value (μm) | | | | | | | | | | | |

Fibers in the SEM photograph in FIG. 2 were also proportionally measured using SolidWorks 2014 software, and the fiber sizes are shown in Table 2 below.

TABLE 2
Fiber sizes on the first porous outer surface

| | Fiber Number | | | | | | | | |
|---|---|---|---|---|---|---|---|---|---|
| | 1 | 2 | 3 | 4 | 5 | 6 | 7 | 8 | |
| | Measurement Length (mm) | | | | | | | | |
| | 74.5 | 79.06 | 66.19 | 86.23 | 48.64 | 75.67 | 111.93 | 84.03 | |
| | Measurement Width (mm) | | | | | | | | |
| | 12.4 | 8.98 | 14.77 | 18.47 | 12.61 | 16.74 | 16.37 | 10.16 | |
| | Scale | | | | | | | | Average |
| | 504.34:5 | | | | | | | | Value |
| Length - | 0.739 | 0.784 | 0.656 | 0.855 | 0.482 | 0.750 | 1.110 | 0.833 | 0.776 |
| Actual Value | | | | | | | | | |
| (μm) | | | | | | | | | |
| Diameter - | 0.123 | 0.089 | 0.146 | 0.183 | 0.125 | 0.166 | 0.162 | 0.101 | 0.137 |
| Actual Value | | | | | | | | | |
| (μm) | | | | | | | | | |
| Aspect Ratio | 6 | 9 | 4 | 5 | 4 | 5 | 7 | 8 | 6 |

Using SolidWorks 2014 software, the nodes in the SEM photograph in FIG. 3 were proportionally measured, and the node sizes are shown in Table 3 below.

TABLE 3
Node sizes on the second porous outer surface

| | Node Number | | | | | | | | | | | |
|---|---|---|---|---|---|---|---|---|---|---|---|---|
| | 1 | 2 | 3 | 4 | 5 | 6 | 7 | 8 | 9 | 10 | 11 | |
| | Measurement Length (mm) | | | | | | | | | | | |
| | 62.51 | 78.06 | 61.96 | 22.46 | 72.46 | 81.69 | 53.22 | 70.83 | 71.46 | 57.55 | 81.29 | |
| | Measurement Width (mm) | | | | | | | | | | | |
| | 24.73 | 33.02 | 31.43 | 13.45 | 17.71 | 28.98 | 24.84 | 21.58 | 27.14 | 12.92 | 29.75 | |
| | Scale | | | | | | | | | | | Average |
| | 403.68:20 | | | | | | | | | | | Value |
| Length - | 3.097 | 3.867 | 3.070 | 1.113 | 3.590 | 4.047 | 2.637 | 3.509 | 3.540 | 2.851 | 4.027 | 3.214 |
| Actual Value | | | | | | | | | | | | |
| (μm) | | | | | | | | | | | | |
| Width - | 1.225 | 1.636 | 1.557 | 0.666 | 0.877 | 1.436 | 1.231 | 1.069 | 1.345 | 0.640 | 1.474 | 1.196 |
| Actual Value | | | | | | | | | | | | |
| (μm) | | | | | | | | | | | | |

Using SolidWorks 2014 software, the fibers in the SEM photograph in FIG. 3 were measured proportionally, and the fiber sizes are shown in Table 4.

TABLE 4
Fiber sizes of the second porous outer surface

| | Fiber Number | | | | | | | | | |
|---|---|---|---|---|---|---|---|---|---|---|
| | 1 | 2 | 3 | 4 | 5 | 6 | 7 | 8 | 9 | |
| | Measurement Length (mm) | | | | | | | | | |
| | 147.27 | 191.61 | 218.32 | 228.25 | 158.72 | 102.49 | 72.48 | 104.78 | 210.76 | |
| | Measurement Width (mm) | | | | | | | | | |
| | 6.75 | 9.86 | 8.42 | 5.66 | 7.61 | 6.07 | 4.72 | 7.45 | 4.85 | |
| | Scale | | | | | | | | | Average |
| | 503.96:10 | | | | | | | | | Value |
| Length - | 2.922 | 3.802 | 4.332 | 4.529 | 3.149 | 2.034 | 1.438 | 2.079 | 4.182 | 3.163 |
| Actual Value | | | | | | | | | | |
| (μm) | | | | | | | | | | |
| Diameter - | 0.134 | 0.196 | 0.167 | 0.112 | 0.151 | 0.120 | 0.094 | 0.148 | 0.096 | 0.135 |
| Actual Value | | | | | | | | | | |
| (μm) | | | | | | | | | | |
| Aspect Ratio | 22 | 19 | 26 | 40 | 21 | 17 | 15 | 14 | 43 | 24 |

Two test conditions were used with a capillary flow porometer to measure the bubble point. In a first test, the first porous outer surface of the PTFE membrane faced a metal mesh, and in a second test, the second porous outer surface of the PTFE membrane faced the metal mesh, resulting in bubble points of 1.97 bar and 1.62 bar, respectively.

### Embodiment 2

Daikin F-106 polytetrafluoroethylene (PTFE) dispersion resin was uniformly mixed with 19.5% by weight of isoalkane (ExxonMobil ISOPAR M) and placed in a constant temperature oven at 25° C. for 20 hours. The PTFE resin mixture was pressed into a cylindrical preform and then extruded through a T-shaped die at a compression ratio of 195 to obtain a continuous first strip sheet with a rectangular cross-section. A thickness of the first strip sheet was 0.4 mm.

Asahi Glass CD-126E PTFE dispersion resin was uniformly mixed with 23.5% by weight of isoalkane (ExxonMobil ISOPAR K) and placed in a constant temperature oven at 25° C. for 20 hours. The PTFE resin mixture was pressed into a cylindrical preform and then extruded through T-shaped dies with different specifications at a compression ratio of 56 to obtain a continuous second strip sheet with a rectangular cross-section and, and at a compression ratio of 45 to obtain a continuous third strip with a rectangular cross-section, respectively. A thickness of the second strip sheet was 0.8 mm and a thickness of the third strip sheet was 1.0 mm.

The three strip sheets with different thicknesses were stacked along a width direction of the three strip sheets in an increasing or decreasing order of thickness, then passed through a pair of metal rollers along a length direction of the three strip sheets, and calendered in a thickness direction of the three strip sheets to 0.28 mm to form a laminate. The laminate was dried to remove additive oil, and then the dried laminate was expanded in a speed direction using a longitudinal stretching mechanism at a roller temperature of 300° C. with a stretching rate of 150%/sec and an expansion ratio of 250%. The longitudinally stretched product (base band) was then transversely expanded (i.e., expanded in a direction perpendicular to the speed direction) using a transverse stretching machine at a stretching temperature of 250° C. with a stretching rate of 22%/sec and an expansion ratio of 2000%. Finally, the stretched product was heat-set to form a PTFE membrane.

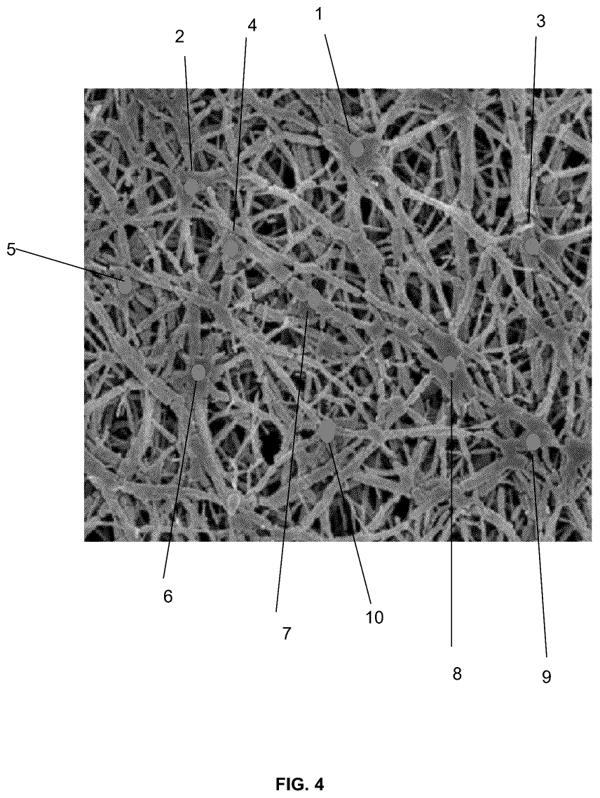

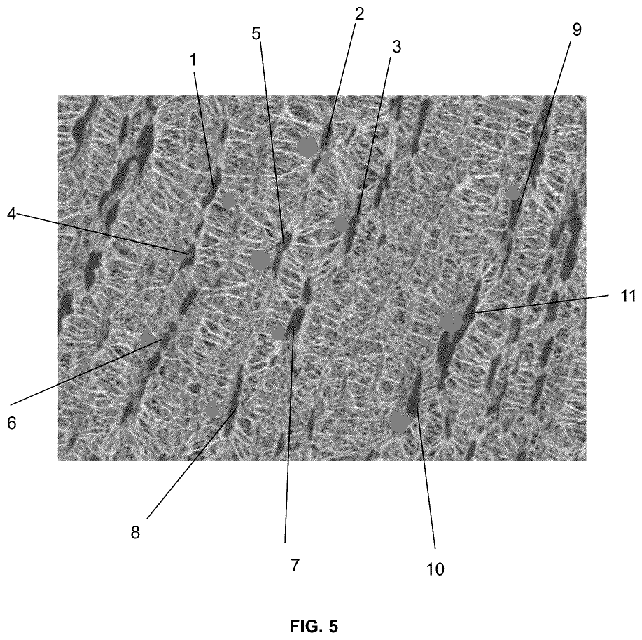

As described above, the obtained PTFE membrane has a first porous outer surface and a second porous outer surface with different microstructures. As shown in FIGS. 4-5, FIG. 4 is a scanning electron microscope (SEM) photograph taken at 2000× magnification of the first porous outer surface of the PTFE membrane, showing an island-like microstructure formed by a plurality of interconnected relatively-small nodes. FIG. 5 is an SEM photograph taken at 2000× magnification of the second porous outer surface of the PTFE membrane, showing an H-shaped ladder-like microstructure formed by a plurality of interconnected relatively-large nodes.

The nodes in the SEM photograph in FIG. 4 were proportionally measured using SolidWorks 2014 software. The node sizes are shown in Table 5 below.

TABLE 5
Node sizes on the first porous outer surface

| | Node Number | | | | | | | | | | |
|---|---|---|---|---|---|---|---|---|---|---|---|
| | 1 | 2 | 3 | 4 | 5 | 6 | 7 | 8 | 9 | 10 | |
| | Measurement Diameter (mm) | | | | | | | | | | |
| | 92.97 | 64.05 | 95.04 | 76.44 | 80.57 | 88.84 | 64.82 | 95.04 | 123.96 | 56.82 | |
| | Scale | | | | | | | | | | Average |
| | 504.34:5 | | | | | | | | | | Value |
| Diameter - | 0.922 | 0.635 | 0.942 | 0.758 | 0.799 | 0.881 | 0.643 | 0.942 | 1.229 | 0.563 | 0.831 |
| Actual Value | | | | | | | | | | | |
| (μm) | | | | | | | | | | | |

Fibers in the SEM photograph in FIG. 4 were also proportionally measured using SolidWorks 2014 software, and the fiber sizes are shown in Table 6 below.

TABLE 6
Fiber sizes on the first porous outer surface

| | Fiber Number | | | | | | | | |
|---|---|---|---|---|---|---|---|---|---|
| | 1 | 2 | 3 | 4 | 5 | 6 | 7 | 8 | |
| | Measurement Length (mm) | | | | | | | | |
| | 81.95 | 86.966 | 72.809 | 94.853 | 53.504 | 83.237 | 123.123 | 92.433 | |
| | Measurement Width (mm) | | | | | | | | |
| | 11.78 | 8.531 | 14.0315 | 17.5465 | 11.9795 | 15.903 | 15.5515 | 9.652 | |
| | Scale | | | | | | | | Average |
| | 504.34:5 | | | | | | | | Value |
| Length - | 0.812 | 0.862 | 0.722 | 0.940 | 0.530 | 0.825 | 1.221 | 0.916 | 0.854 |
| Actual Value | | | | | | | | | |
| (μm) | | | | | | | | | |
| Diameter - | 0.117 | 0.085 | 0.139 | 0.174 | 0.119 | 0.158 | 0.154 | 0.096 | 0.130 |
| Actual Value | | | | | | | | | |
| (μm) | | | | | | | | | |
| Aspect Ratio | 7 | 10 | 5 | 5 | 4 | 5 | 8 | 10 | 7 |

Using SolidWorks 2014 software, the nodes in the SEM photograph in FIG. 5 were proportionally measured, and the node sizes are shown in Table 7 below.

TABLE 7
Node sizes on the second porous outer surface

| | Node Number | | | | | | | | | | | |
|---|---|---|---|---|---|---|---|---|---|---|---|---|
| | 1 | 2 | 3 | 4 | 5 | 6 | 7 | 8 | 9 | 10 | 11 | |
| | Measurement Length (mm) | | | | | | | | | | | |
| | 65.64 | 81.96 | 65.06 | 23.58 | 76.08 | 83.73 | 54.55 | 72.60 | 73.25 | 58.99 | 83.32 | |
| | Measurement Width (mm) | | | | | | | | | | | |
| | 24.24 | 32.36 | 30.80 | 13.18 | 17.36 | 28.40 | 24.34 | 21.15 | 26.60 | 12.66 | 29.16 | |
| | Scale | | | | | | | | | | | Average |
| | 403.68:20 | | | | | | | | | | | Value |
| Length - | 3.252 | 4.061 | 3.223 | 1.168 | 3.769 | 4.148 | 2.703 | 3.597 | 3.629 | 2.923 | 4.128 | 3.327 |
| Actual Value | | | | | | | | | | | | |
| (μm) | | | | | | | | | | | | |
| Width - | 1.201 | 1.603 | 1.526 | 0.653 | 0.860 | 1.407 | 1.206 | 1.048 | 1.318 | 0.627 | 1.444 | 1.172 |
| Actual Value | | | | | | | | | | | | |
| (μm) | | | | | | | | | | | | |

Using SolidWorks 2014 software, the fibers in the SEM photograph in FIG. 5 were measured proportionally, and the fiber sizes are shown in Table 8.

TABLE 8
Fiber sizes of the second porous outer surface

| | Fiber Number | | | | | | | | | |
|---|---|---|---|---|---|---|---|---|---|---|
| | 1 | 2 | 3 | 4 | 5 | 6 | 7 | 8 | 9 | |
| | Measurement Length (mm) | | | | | | | | | |
| | 150.22 | 195.44 | 222.66 | 232.82 | 161.89 | 104.54 | 73.93 | 106.88 | 214.98 | |
| | Measurement Width (mm) | | | | | | | | | |
| | 6.41 | 9.37 | 8.00 | 5.38 | 7.23 | 5.77 | 4.48 | 7.08 | 4.61 | |
| | Scale | | | | | | | | | Average |
| | 503.96:10 | | | | | | | | | Value |
| Length - | 2.981 | 3.878 | 4.419 | 4.620 | 3.212 | 2.074 | 1.467 | 2.121 | 4.266 | 3.226 |
| Actual Value | | | | | | | | | | |
| (μm) | | | | | | | | | | |
| Diameter - | 0.127 | 0.186 | 0.159 | 0.107 | 0.143 | 0.114 | 0.089 | 0.140 | 0.091 | 0.129 |
| Actual Value | | | | | | | | | | |
| (μm) | | | | | | | | | | |
| Aspect Ratio | 23 | 21 | 28 | 43 | 22 | 18 | 16 | 15 | 47 | 26 |

Two test conditions were used with a capillary flow porometer to measure the bubble point. In a first test, the first porous outer surface of the PTFE membrane faced a metal mesh, and in a second test, the second porous outer surface of the PTFE membrane faced the metal mesh, resulting in bubble points of 1.78 bar and 1.53 bar, respectively.

### Embodiment 3

Daikin F-106 polytetrafluoroethylene (PTFE) dispersion resin was uniformly mixed with 21.3% by weight of isoalkane (ExxonMobil ISOPAR M) and placed in a constant temperature oven at 25° C. for 22 hours. The PTFE resin mixture is pressed into a cylindrical preform and then extruded through a T-shaped die at a compression ratio of 195 to obtain a continuous first strip sheet with a rectangular cross-section. A thickness of the first strip sheet was 0.4 mm.

Asahi Glass CD-126E PTFE dispersion resin was uniformly mixed with 25.5% by weight of isoalkane (ExxonMobil ISOPAR K) and placed in a constant temperature oven at 25° C. for 22 hours. The PTFE resin mixture was pressed into a cylindrical preform and then extruded through T-shaped dies with different specifications at a compression ratio of 56 to obtain a continuous second strip sheet with a rectangular cross-section and, and at a compression ratio of 37 to obtain a continuous third strip with a rectangular cross-section, respectively. A thickness of the second strip sheet is 0.8 mm and a thickness of the third strip sheet is 1.2 mm.

The three strip sheets with different thicknesses were stacked along a width direction of the three strip sheets in an increasing or decreasing order of thickness, then passed through a pair of metal rollers along a length direction of the three strip sheets, and calendered in a thickness direction of the three strip sheets to 0.32 mm to form a laminate. The laminate was dried to remove additive oil, and then the dried laminate was expanded in a speed direction using a longitudinal stretching mechanism at a roller temperature of 300° C. with a stretching rate of 66.7%/sec and an expansion ratio of 200%. The longitudinally stretched product (base band) was then transversely expanded (i.e., expanded in a direction perpendicular to the speed direction) using a transverse stretching machine at a stretching temperature of 250° C. with a stretching rate of 22%/sec and an expansion ratio of 2000%. Finally, the stretched product was heat-set to form a PTFE membrane.

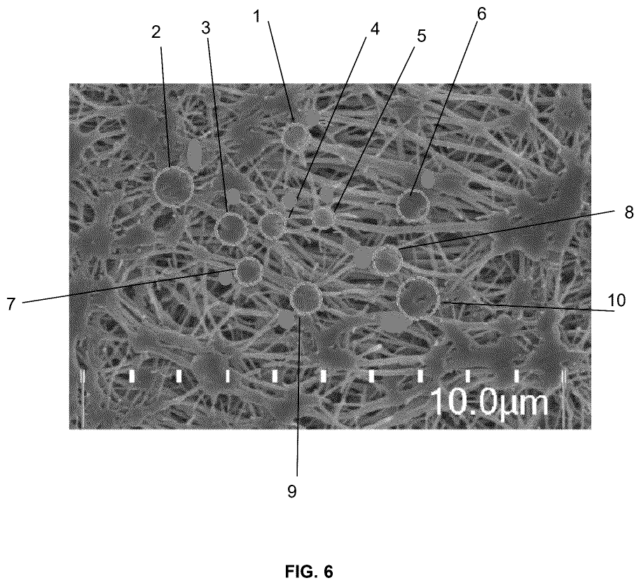

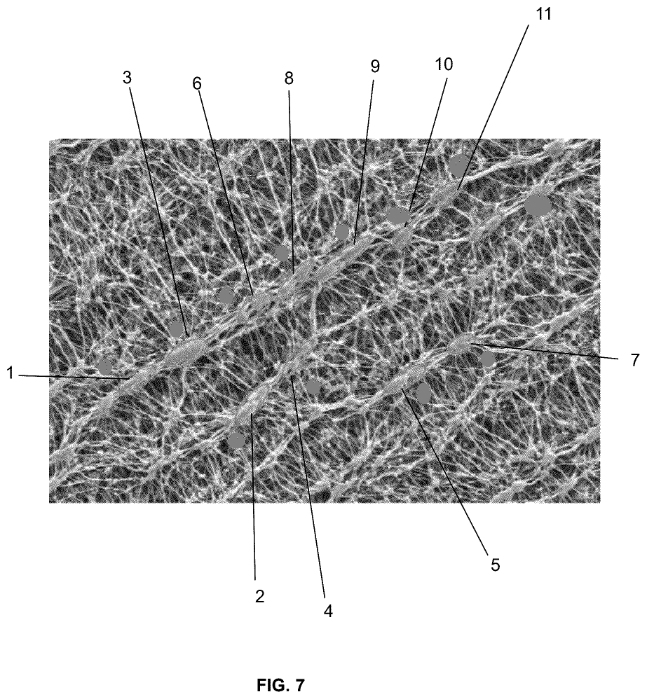

As described above, the obtained PTFE membrane has a first porous outer surface and a second porous outer surface with different microstructures. As shown in FIGS. 6-7, FIG. 6 is a scanning electron microscope (SEM) photograph taken at 2000× magnification of the first porous outer surface of the PTFE membrane, showing an island-like microstructure formed by a plurality of interconnected relatively-small nodes. FIG. 7 is an SEM photograph taken at 2000× magnification of the second porous outer surface of the PTFE membrane, showing an H-shaped ladder-like microstructure formed by a plurality of interconnected relatively-large nodes.

The nodes in the SEM photograph in FIG. 6 were proportionally measured using SolidWorks 2014 software. The node sizes are shown in Table 9 below.

TABLE 9
Node sizes on the first porous outer surface

| | Node Number | | | | | | | | | | |
|---|---|---|---|---|---|---|---|---|---|---|---|
| | 1 | 2 | 3 | 4 | 5 | 6 | 7 | 8 | 9 | 10 | |
| | Measurement Diameter (mm) | | | | | | | | | | |
| | 27.54 | 41.17 | 32.35 | 27.63 | 22.8 | 32.74 | 28.36 | 29.86 | 32.13 | 43.23 | |
| | Scale | | | | | | | | | | Average |
| | 504.53:10 | | | | | | | | | | Value |
| Diameter - | 0.273 | 0.408 | 0.321 | 0.274 | 0.226 | 0.325 | 0.281 | 0.296 | 0.319 | 0.429 | 0.315 |
| Actual Value | | | | | | | | | | | |
| (μm) | | | | | | | | | | | |

Fibers in the SEM photograph in FIG. 6 were also proportionally measured using SolidWorks 2014 software, and the fiber sizes are shown in Table 10 below.

TABLE 10
Fiber sizes on the first porous outer surface

| | Fiber Number | | | | | | | | |
|---|---|---|---|---|---|---|---|---|---|
| | 1 | 2 | 3 | 4 | 5 | 6 | 7 | 8 | |
| | Measurement Length (mm) | | | | | | | | |
| | 50.2 | 59.94 | 33.84 | 29.45 | 151.49 | 100.24 | 34.98 | 105.09 | |
| | Measurement Width (mm) | | | | | | | | |
| | 6.52 | 4.85 | 3.99 | 6.33 | 9.05 | 10.22 | 4.33 | 6.9 | |
| | Scale | | | | | | | | Average |
| | 504.53:10 | | | | | | | | Value |
| Length - | 0.498 | 0.594 | 0.335 | 0.292 | 1.502 | 0.994 | 0.347 | 1.042 | 0.700 |
| Actual Value | | | | | | | | | |
| (μm) | | | | | | | | | |
| Diameter - | 0.065 | 0.048 | 0.040 | 0.063 | 0.090 | 0.101 | 0.043 | 0.068 | 0.065 |
| Actual Value | | | | | | | | | |
| (μm) | | | | | | | | | |
| Aspect Ratio | 8 | 12 | 8 | 5 | 17 | 10 | 8 | 15 | 10 |

Using SolidWorks 2014 software, the nodes in the SEM photograph in FIG. 7 were proportionally measured, and the node sizes are shown in Table 11 below.

TABLE 11
Node sizes on the second porous outer surface

| | Node Number | | | | | | | | | | | |
|---|---|---|---|---|---|---|---|---|---|---|---|---|
| | 1 | 2 | 3 | 4 | 5 | 6 | 7 | 8 | 9 | 10 | 11 | |
| | Measurement Length (mm) | | | | | | | | | | | |
| | 41.82 | 46.73 | 44.48 | 44.48 | 46.15 | 39.74 | 28.43 | 50.01 | 65.73 | 24.95 | 33.1 | |
| | Measurement Width (mm) | | | | | | | | | | | |
| | 14.92 | 15.24 | 19.89 | 12.59 | 15.04 | 13.48 | 15.56 | 13.48 | 13.95 | 14.06 | 15.54 | |
| | Scale | | | | | | | | | | | Average |
| | 90.1:10 | | | | | | | | | | | Value |
| Length - | 4.642 | 5.186 | 4.937 | 4.937 | 5.122 | 4.411 | 3.155 | 5.550 | 7.295 | 2.769 | 3.674 | 4.698 |
| Actual Value | | | | | | | | | | | | |
| (μm) | | | | | | | | | | | | |
| Width - | 1.656 | 1.691 | 2.208 | 1.397 | 1.669 | 1.496 | 1.727 | 1.496 | 1.548 | 1.560 | 1.725 | 1.652 |
| Actual Value | | | | | | | | | | | | |
| (μm) | | | | | | | | | | | | |

Using SolidWorks 2014 software, the fibers in the SEM photograph in FIG. 7 were measured proportionally, and the fiber sizes are shown in Table 12.

TABLE 12
Fiber sizes of the second porous outer surface

| | Fiber Number | | | | | | | | | |
|---|---|---|---|---|---|---|---|---|---|---|
| | 1 | 2 | 3 | 4 | 5 | 6 | 7 | 8 | 9 | |
| | Measurement Length (mm) | | | | | | | | | |
| | 220.7 | 225.62 | 211.24 | 313.09 | 196.46 | 261.26 | 186.8 | 237.41 | 190.19 | |
| | Measurement Width (mm) | | | | | | | | | |
| | 6.43 | 6.03 | 6.24 | 7.13 | 3.73 | 4.6 | 3.09 | 3.88 | 6.34 | |
| | Scale | | | | | | | | | Average |
| | 89.76:2 | | | | | | | | | Value |
| Length - | 4.918 | 5.027 | 4.707 | 6.976 | 4.377 | 5.821 | 4.162 | 5.290 | 4.238 | 5.057 |
| Actual Value | | | | | | | | | | |
| (μm) | | | | | | | | | | |
| Diameter - | 0.143 | 0.134 | 0.139 | 0.159 | 0.083 | 0.102 | 0.069 | 0.086 | 0.141 | 0.118 |
| Actual Value | | | | | | | | | | |
| (μm) | | | | | | | | | | |
| Aspect Ratio | 34 | 37 | 34 | 44 | 53 | 57 | 60 | 61 | 30 | 46 |

Two test conditions were used with a capillary flow porometer to measure the bubble point. In a first test, the first porous outer surface of the PTFE membrane faced a metal mesh, and in a second test, the second porous outer surface of the PTFE membrane faced the metal mesh, resulting in bubble points of 2.16 bar and 1.51 bar, respectively.

### Embodiment 4

Polytetrafluoroethylene (PTFE) dispersion resin was uniformly mixed with 19.5% by weight of isoalkane and placed in a constant temperature oven at 25° C. for 20 hours. The PTFE resin mixture was pressed into a cylindrical preform and then extruded through a T-shaped die at a compression ratio of 190 to obtain a continuous first strip sheet with a rectangular cross-section. A thickness of the first strip sheet was 0.5 mm.

PTFE dispersion resin was uniformly mixed with 23.5% by weight of isoalkane and placed in a constant temperature oven at 25° C. for 20 hours. The PTFE resin mixture was pressed into a cylindrical preform and then extruded through T-shaped dies with different specifications at a compression ratio of 56 to obtain a continuous second strip sheet with a rectangular cross-section and, and at a compression ratio of 45 to obtain a continuous third strip with a rectangular cross-section, respectively. A thickness of the second strip sheet was 0.8 mm and a thickness of the third strip sheet was 1.0 mm.

The three strip sheets with different thicknesses were stacked along a width direction of the three strip sheets in an increasing or decreasing order of thickness, then passed through a pair of metal rollers along a length direction of the three strip sheets, and calendered in a thickness direction of the three strip sheets to 0.28 mm to form a laminate. The laminate was dried to remove additive oil, and then the dried laminate was expanded in a speed direction using a longitudinal stretching mechanism at a roller temperature of 300° C. with a stretching rate of 150%/sec and an expansion ratio of 250%. The longitudinally stretched product (base band) was then transversely expanded (i.e., expanded in a direction perpendicular to the speed direction) using a transverse stretching machine at a stretching temperature of 250° C. with a stretching rate of 22%/sec and an expansion ratio of 2000%. Finally, the stretched product was heat-set to form a PTFE membrane.

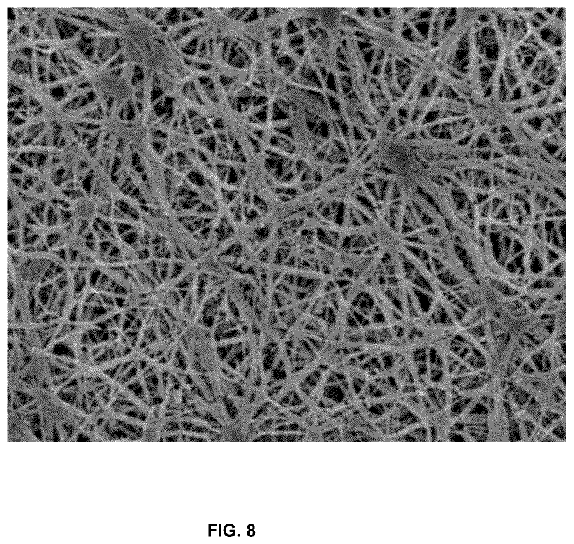

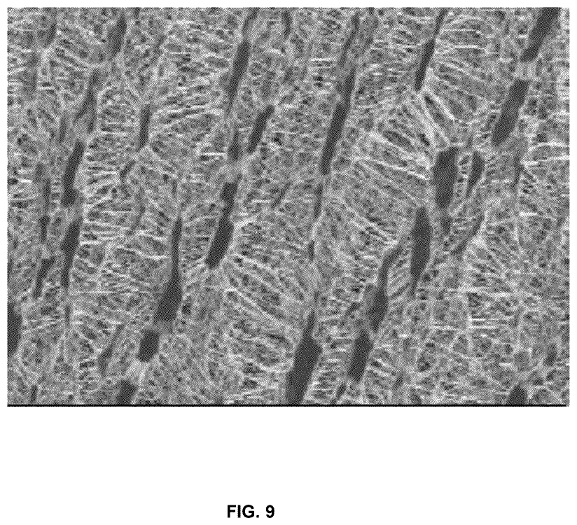

As described above, the obtained PTFE membrane has a first porous outer surface and a second porous outer surface with different microstructures. As shown in FIGS. 8-9, FIG. 8 is a scanning electron microscope (SEM) photograph taken at 2000× magnification of the first porous outer surface of the PTFE membrane, showing an island-like microstructure formed by a plurality of interconnected relatively-small nodes. FIG. 9 is an SEM photograph taken at 2000× magnification of the second porous outer surface of the PTFE membrane, showing an H-shaped ladder-like microstructure formed by a plurality of interconnected relatively-large nodes.

Two test conditions were used with a capillary flow porometer to measure the bubble point. In a first test, the first porous outer surface of the PTFE membrane faced a metal mesh, and in a second test, the second porous outer surface of the PTFE membrane faced the metal mesh, resulting in bubble points of 2.89 bar and 1.61 bar, respectively.

### Embodiment 5

Daikin F-106 polytetrafluoroethylene (PTFE) dispersion resin was uniformly mixed with 21.3% by weight of isoalkane (ExxonMobil ISOPAR M) and placed in a constant temperature oven at 25° C. for 22 hours. The PTFE resin mixture was pressed into a cylindrical preform and then extruded through a T-shaped die at a compression ratio of 195 to obtain a continuous first strip sheet with a rectangular cross-section. A thickness of the first strip sheet was 0.4 mm.

Asahi Glass CD-126E PTFE dispersion resin was uniformly mixed with 25.5% by weight of isoalkane (ExxonMobil ISOPAR K) and placed in a constant temperature oven at 25° C. for 22 hours. The PTFE resin mixture was pressed into a cylindrical preform and then extruded through T-shaped dies with different specifications at a compression ratio of 56 to obtain a continuous second strip sheet with a rectangular cross-section and, and at a compression ratio of 37 to obtain a continuous third strip with a rectangular cross-section, respectively. A thickness of the second strip sheet was 0.8 mm and a thickness of the third strip sheet was 1.2 mm.

The three strip sheets with different thicknesses were stacked along a width direction of the three strip sheets in an increasing or decreasing order of thickness, then passed through a pair of metal rollers along a length direction of the three strip sheets, and calendered in a thickness direction of the three strip sheets to 0.32 mm to form a laminate. The laminate was dried to remove additive oil, and then the dried laminate was expanded in a speed direction using a longitudinal stretching mechanism at a roller temperature of 300° C. with a stretching rate of 66.7%/sec and an expansion ratio of 200%. The longitudinally stretched product (base band) was then transversely expanded (i.e., expanded in a direction perpendicular to the speed direction) using a transverse stretching machine at a stretching temperature of 250° C. with a stretching rate of 22%/sec and an expansion ratio of 2000%. Finally, the stretched product was heat-set to form a PTFE membrane.

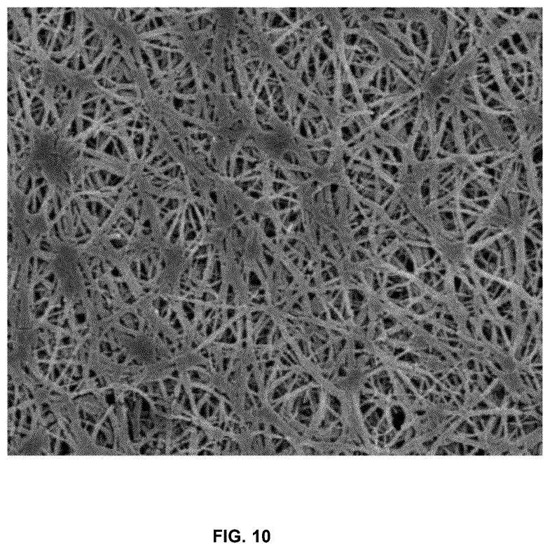

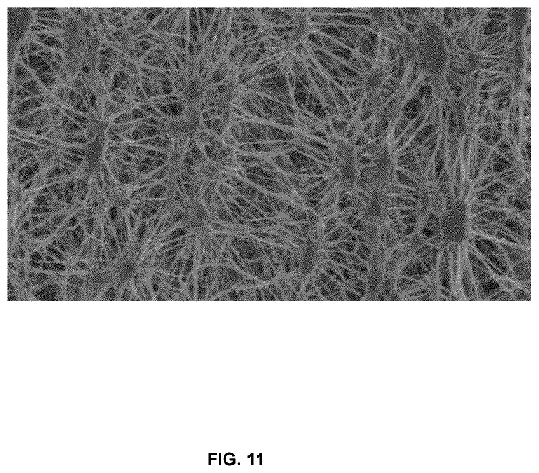

As described above, the obtained PTFE membrane has a first porous outer surface and a second porous outer surface with different microstructures. As shown in FIGS. 10-11, FIG. 10 is a scanning electron microscope (SEM) photograph taken at 2000× magnification of the first porous outer surface of the PTFE membrane, showing an island-like microstructure formed by a plurality of interconnected relatively-small nodes. FIG. 11 is an SEM photograph taken at 2000× magnification of the second porous outer surface of the PTFE membrane, showing an H-shaped ladder-like microstructure formed by a plurality of interconnected relatively-large nodes.

Two test conditions were used with a capillary flow porometer to measure the bubble point. In a first test, the first porous outer surface of the PTFE membrane faced a metal mesh, and in a second test, the second porous outer surface of the PTFE membrane faced the metal mesh, resulting in bubble points of 2.35 bar and 1.77 bar, respectively.

### Embodiment 6

Polytetrafluoroethylene (PTFE) dispersion resin was uniformly mixed with 21.3% by weight of isoalkane (ExxonMobil ISOPAR M) and placed in a constant temperature oven at 30° C. for 15 hours. The PTFE resin mixture was pressed into a cylindrical preform and then extruded through a T-shaped die at a compression ratio of 190 to obtain a continuous first strip sheet with a rectangular cross-section. A thickness of the first strip sheet was 0.5 mm.

PTFE dispersion resin was uniformly mixed with 26.2% by weight of isoalkane (ExxonMobil ISOPAR K) and placed in a constant temperature oven at 30° C. for 15 hours. The PTFE resin mixture was pressed into a cylindrical preform and then extruded through T-shaped dies with different specifications at a compression ratio of 56 to obtain a continuous second strip sheet with a rectangular cross-section and, and at a compression ratio of 37 to obtain a continuous third strip with a rectangular cross-section, respectively. A thickness of the second strip sheet was 0.8 mm and a thickness of the third strip sheet was 1.2 mm.

The three strip sheets with different thicknesses were stacked along a width direction of the three strip sheets in an increasing or decreasing order of thickness, then passed through a pair of metal rollers along a length direction of the three strip sheets, and calendered in a thickness direction of the three strip sheets to 0.3 mm to form a laminate. The laminate was dried to remove additive oil, and then the dried laminate was expanded in a speed direction using a longitudinal stretching mechanism at a roller temperature of 300° C. with a stretching rate of 117%/sec and an expansion ratio of 230%. The longitudinally stretched product (base band) was then transversely expanded (i.e., expanded in a direction perpendicular to the speed direction) using a transverse stretching machine at a stretching temperature of 250° C. with a stretching rate of 22%/sec and an expansion ratio of 2000%. Finally, the stretched product was heat-set to form a PTFE membrane.

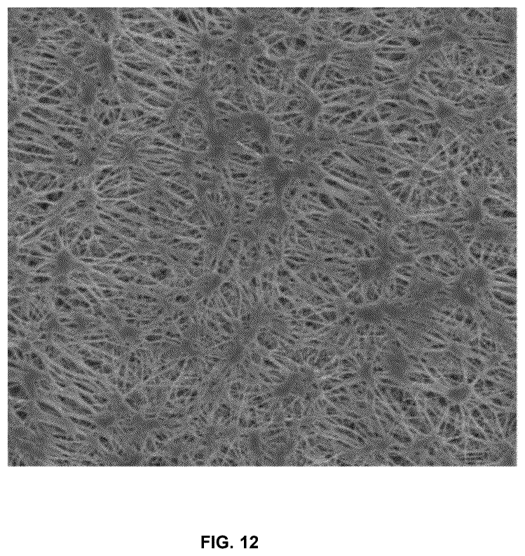

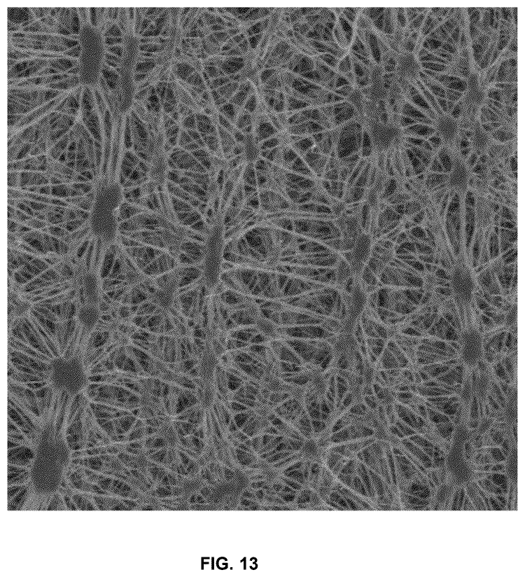

As described above, the obtained PTFE membrane has a first porous outer surface and a second porous outer surface with different microstructures. As shown in FIGS. 12-13, FIG. 12 is a scanning electron microscope (SEM) photograph taken at 2000× magnification of the first porous outer surface of the PTFE membrane, showing an island-like microstructure formed by a plurality of interconnected relatively-small nodes. FIG. 13 is an SEM photograph taken at 2000× magnification of the second porous outer surface of the PTFE membrane, showing an H-shaped ladder-like microstructure formed by a plurality of interconnected relatively-large nodes.

Two test conditions were used with a capillary flow porometer to measure the bubble point. In a first test, the first porous outer surface of the PTFE membrane faced a metal mesh, and in a second test, the second porous outer surface of the PTFE membrane faced the metal mesh, resulting in bubble points of 2.12 bar and 1.68 bar, respectively.

The detailed descriptions listed above are merely specific explanations of feasible embodiments of the present disclosure and are not intended to limit the scope of protection of the invention. Any equivalent embodiments or modifications that do not depart from the spirit of the present disclosure should be included within the scope of protection of the present disclosure.

Moreover, it should be understood that although the present disclosure is described according to embodiments, not every embodiment necessarily includes only a single independent technical solution. The manner of description in present disclosure is for the sake of clarity. Those skilled in the art should consider the present disclosure as a whole, and the technical solutions in various embodiments may also be appropriately combined to form other embodiments that may be understood by those skilled in the art.

1. A polytetrafluoroethylene (PTFE) membrane with a gradient pore structure, wherein a cross-section of the PTFE membrane has the gradient pore structure, and a first porous outer surface and a second porous outer surface of the PTFE membrane have fibers and nodes with different microstructures, the first porous outer surface has an island-like microstructure formed by a plurality of interconnected relatively-small nodes, and the second porous outer surface has an H-shaped ladder-like microstructure formed by a plurality of interconnected relatively-large nodes.

2. The PTFE membrane with the gradient pore structure of claim 1, wherein each of the relatively-small nodes has a circular structure, and an average diameter of the relatively-small nodes is in a range of 0.30 μm to 1.50 μm.

3. The PTFE membrane with the gradient pore structure of claim 2, wherein the relatively-small nodes are connected by a plurality of short and thick microfibers, an average length of the short and thick microfibers is in a range of 0.2 μm to 2.5 μm, an average diameter of the short and thick microfibers is in a range of 0.05 μm to 0.2 μm, and an aspect ratio of the short and thick microfibers is in a range of 2 to 20.

4. The PTFE membrane with the gradient pore structure of claim 1, wherein each of the relatively-large nodes has an elongated oval structure, an average length of the relatively-large nodes is in a range of 0.5 μm to 10 μm, and an average width of the relatively-large nodes is in a range of 0.5 μm to 2 μm.

5. The PTFE membrane with the gradient pore structure of claim 4, wherein the relatively-large nodes are connected by a plurality of long and thin microfibers, an average length of the long and thin microfibers is in a range of 1 μm to 10 μm, an average diameter of the long and thin microfibers is in a range of 5 nm to 200 nm, and an aspect ratio of the long and thin microfibers is in a range of 10 to 200.

6. A method for preparing the polytetrafluoroethylene (PTFE) membrane with the gradient pore structure as claimed in claim 1, comprising:
mixing isoalkane with PTFE dispersion resin to obtain a PTFE resin mixture, and pressing the PTFE resin mixture into a cylindrical preform;
extruding, using an extruder and T-shaped extrusion dies with different specifications, the cylindrical preform into three continuous rectangular strip sheets with different thicknesses and a same width, designated as a first sheet, a second sheet, and a third sheet;
stacking the first sheet, the second sheet, and the third sheet along a width direction of the three strip sheets in an increasing or decreasing order of thickness, and passing the three strip sheets through a pair of metal rollers along a length direction of the three strip sheets to be calendered to a thickness in a range of 0.05 mm to 1 mm, forming a laminate;
drying the laminate at a temperature in a range of 200° C. to 250° C., and expanding the laminate in a speed direction at a temperature in a range of 250° C. to 350° C. with a stretching rate in a range of 20%/s to 3000%/s and an expansion ratio in a range of 50% to 900%, forming a uniaxially stretched product; and
expanding the uniaxially stretched product at a temperature in a range of 200° C. to 400° C. with a stretching rate in a range of 5%/s to 500%/s and an expansion ratio in a range of 300% to 3000% in a direction perpendicular to the speed direction, thereby forming the PTFE membrane with the gradient pore structure.

7. The method for preparing the PTFE membrane with the gradient pore structure of claim 6, wherein the isoalkane and the PTFE dispersion resin are uniformly mixed in a weight ratio in a range of 15% to 30% to obtain the PTFE resin mixture, and the PTFE resin mixture is dried at a temperature not less than 20° C. for more than 12 hours before being pressed as the cylindrical preform.

8. The method for preparing the PTFE membrane with the gradient pore structure of claim 7, wherein the cylindrical preform is extruded through the T-shaped extrusion dies with different specifications at a compression ratio in a range of 20 to 500 to form the three continuous rectangular strip sheets with different thicknesses and the same width, designated as the first sheet, the second sheet, and the third sheet, wherein:
a thickness of the second sheet is at least 1.2 times of a thickness of the first sheet, a thickness of the third sheet is at least 1.2 times of the thickness of the second sheet, and a compression ratio for the first sheet is at least 2.5 times of a compression ratio for the second sheet and 3 times of a compression ratio for the third sheet.

9. The method for preparing the PTFE membrane with the gradient pore structure of claim 8, wherein the laminate is expanded in the speed direction at a stretching rate in a range of 50%/s to 2000%/s and an expansion ratio in a range of 80% to 800% to form the uniaxially stretched product.

10. The method for preparing the PTFE membrane with the gradient pore structure of claim 9, wherein the uniaxially stretched product is expanded in the direction perpendicular to the speed direction at a stretching rate in a range of 20%/s to 300%/s and an expansion ratio in a range of 500% to 2500%, thereby forming the PTFE membrane with the gradient pore structure.
